(19) United States
(12) Patent Application Publication
(10) Pub. No.: US 2011/0029108 A1
(43) Pub. Date: Feb. 3, 2011

(54) MUSIC GENRE CLASSIFICATION METHOD AND APPARATUS

(76) Inventors: Jeehyong Lee, Yongsan-gu (KR); Hyewuk Jung, Dongjak-gu (KR); Sungwoo Bang, Seongam-si (KR)

Correspondence Address: SHERR & VAUGHN, PLLC, 620 HERNDON PARKWAY, SUITE 320, HERNDON, VA, 20170, US

(21) Appl. No.: 12/697,336

(22) Filed: Feb. 1, 2010

(30) Foreign Application Priority Data
Aug. 3, 2009 (KR) 10-2009-071196

(51) Int. Cl. G06F 17/00

(52) U.S. Cl. 700/94

(57) ABSTRACT

A method for music genre classification includes generating Hidden Markov Models corresponding to a plurality of audio files, and classifying the audio files according to music genres by clustering the audio files based on the similarity between the generated Hidden Markov Models. The generating Hidden Markov Models corresponding to the plurality of audio files includes performing an Independent Component Analysis (ICA) for audio signal generated from respective audio file consisting of the plurality of audio files to generate independent signals corresponding to the audio signal, selecting at least one independent signal as a main signal among the independent signals based on energies of the generated independent signals, extracting an audio feature parameter from the main signal, and generating Hidden Markov Model for the respective audio file based on the extracted audio feature parameter.

### TECHNICAL FIELD

The described technology relates generally to a method of classifying music files according to genres and an apparatus therefor.

### BACKGROUND

Individual's possession of music files is greatly increased owing to expansion of distribution of MP3 players and popularization of digital music files. Therefore, it is significant to effectively research and manage the music files. For such research and management of the music files, content-based music file classification according to genres is required.

### SUMMARY

In accordance with some embodiments, a method for music genre classification includes generating Hidden Markov Models corresponding to a plurality of audio files, and classifying the audio files according to music genres by clustering the audio files based on the similarity between the generated Hidden Markov Models. The generating Hidden Markov Models corresponding to the plurality of audio files includes performing an Independent Component Analysis (ICA) for audio signal generated from respective audio file consisting of the plurality of audio files to generate independent signals corresponding to the audio signal, selecting at least one independent signal as a main signal among the independent signals based on energies of the generated independent signals, extracting an audio feature parameter from the main signal, and generating Hidden Markov Model for the respective audio file based on the extracted audio feature parameter.

In accordance with some embodiments, an apparatus for music genre classification includes a model generator, which generates Hidden Markov Models corresponding to a plurality of audio files, and an audio file classifier, which classifies the audio files according to music genres by clustering the audio files based on the similarity between the generated Hidden Markov Models. The model generator includes an independent component analyzer that performs an independent component analysis (ICA) for audio signal generated from respective audio file consisting of the plurality of audio files to generate independent signals corresponding to the audio signal, a main signal selector that selects at least one independent signal as a main signal among the independent signals based on energies of the generated independent signals, a feature extractor that extracts an audio feature parameter from the main signal, and a Hidden Markov Model generator that generates Hidden Markov Model for the respective audio file based on the extracted audio feature parameter.

The Summary is provided to introduce a selection of concepts in a simplified form that are further described below in the Detailed Description. The Summary is not intended to identify key features or essential features of the claimed subject matter, nor is it intended to be used as an aid in determining the scope of the claimed subject matter.

### BRIEF DESCRIPTION OF THE DRAWINGS

The above and other features and advantages of the present disclosure will become more apparent to those of ordinary skill in the art by describing in detail example embodiments thereof with reference to the attached drawings in which:

FIG. 1 is a block diagram of an apparatus for music genre classification in one embodiment; and

FIG. 2 is a flowchart illustrating a method for music genre classification in one embodiment.

### DETAILED DESCRIPTION

In the following detailed description, reference is made to the accompanying drawings, which form a part hereof In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the components of the present disclosure, as generally described herein, and illustrated in the Figures, can be arranged, substituted, combined, and designed in a wide variety of different configurations, all of which are explicitly contemplated and make part of this disclosure. It will also be understood that when an element or layer is referred to as being “on” or “connected to” another element or layer, the element or layer may be directly on or connected to the other element or layer or intervening elements or layers may be present.

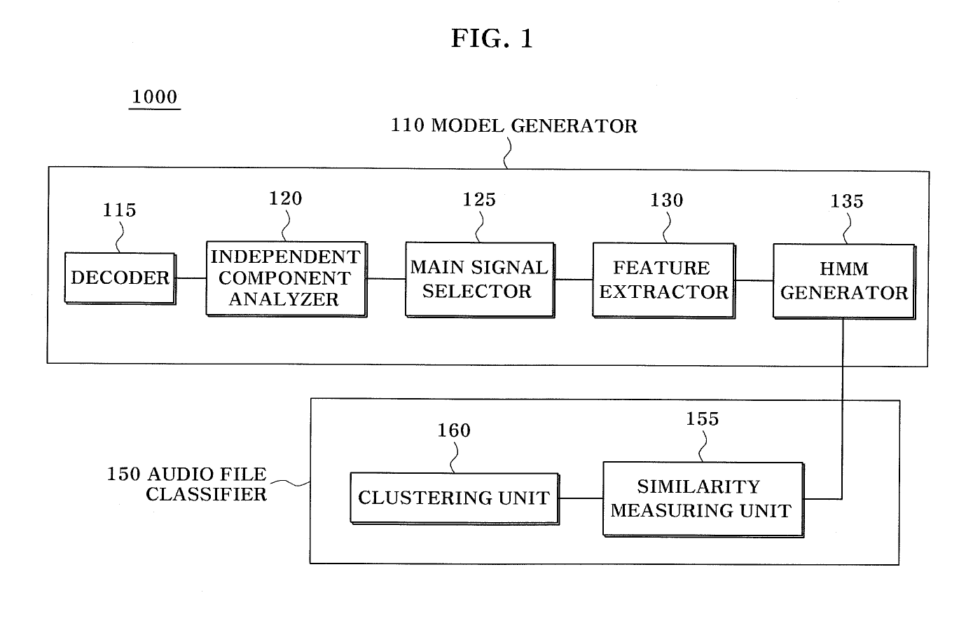

FIG. 1 is a block diagram of an apparatus for music genre classification in one embodiment.

Referring to FIG. 1, a music genre classification apparatus 1000 includes a model generator 110, and an audio file classifier 150. The model generator 110 includes a decoder 115, an independent component analyzer 120, a main signal selector 125, a feature extractor 130, and a Hidden Markov Model (HMM) generator 135. The audio file classifier 150 includes a similarity measuring unit 155 and a clustering unit 160.

The model generator 110 receives a plurality of audio files and generates HMMs corresponding to the audio files.

The audio file classifier 150 clusters the audio files based on the similarities of the generated HMMs to classify the audio files according to music genres.

The decoder 115 decodes the audio file to generate audio signal. The independent component analyzer 120 performs an Independent Component Analysis (ICA) for the audio signal to separate the audio signal into a plurality of independent signals. The ICA is a method for separating linearly mixed signal into statistically independent signals.

The main signal selector 125 selects at least one independent signal as a main signal among the independent signals based on energies of the independent signals. For example, the main signal selector 125 may select, as the main signal, an independent signal having the highest energy among the independent signals by comparing energies of the independent signals. Accordingly, the music genre classification apparatus 1000 may remove signals interfering in deciding music genres for the audio signal and may correctly determine genres of the audio file.

The feature extractor 130 extracts audio feature parameter, which represents the audio feature, from the main signal. For example, the feature extractor 130 may extract Mel Frequency Cepstrum Coefficients (MFCC) from the main signal.

The HMM generator 135 generates probability model that may best represent the extracted audio parameter by using the Hidden Markov Model method. For example, the HMM generator 135 may generate HMM according to the extracted MFCC by training probability model using Baum-Welch algorithm or Segmental K-means algorithm.

The similarity measuring unit 155 measures the similarity between the HMMs. As an example, the similarity measuring unit 155 may measure the similarity between the HMMs by using Dynamic Time Warping (DTW).

The clustering unit 160 clusters the audio files based on the measured similarities. For example, the clustering unit 160 may cluster the audio files by using Markov Clustering Algorithm (MCL Algorithm) based on the measured similarities. Accordingly, the music genre classification apparatus may classify the plurality of audio files according to music genres.

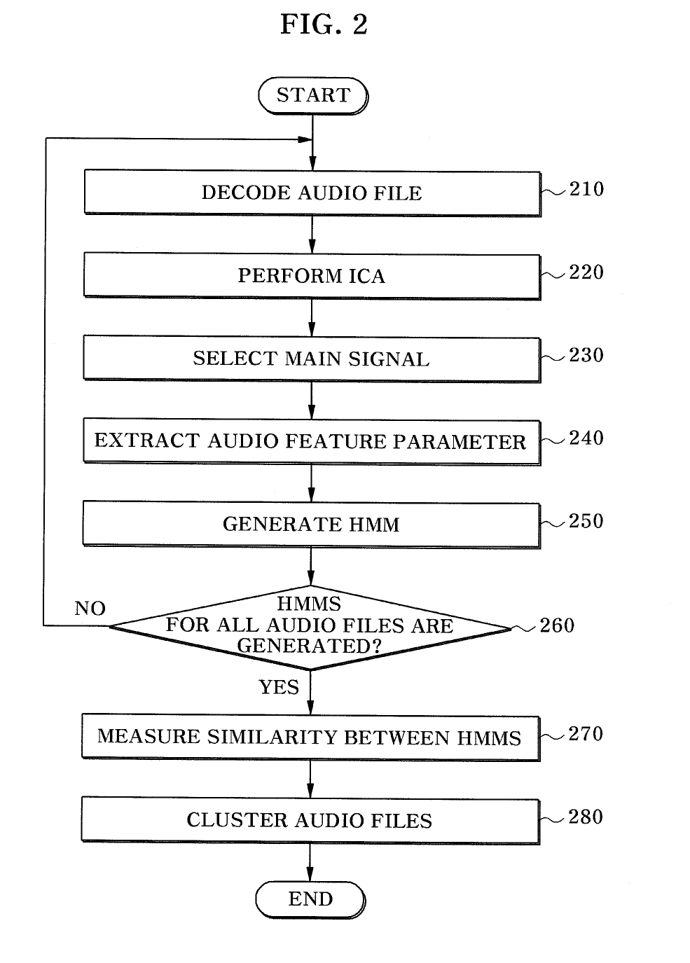

FIG. 2 is a flowchart illustrating a method for music genre classification in one embodiment.

Referring to FIG. 2, the music genre classification apparatus decodes audio file to generate audio signal in step 210.

In step 220, the music genre classification apparatus performs an Independent Component Analysis (ICA) for the audio signal to separate the audio signal into a plurality of independent signals. The ICA is a method for separating linearly mixed signal into statistically independent signals.

In step 230, the music genre classification apparatus selects at least one independent signal as a main signal among the independent signals based on energies of the independent signals. For example, the music genre classification apparatus may select, as the main signal, an independent signal having the highest energy among the independent signals by comparing energies of the independent signals.

In step 240, the music genre classification apparatus extracts an audio feature parameter, which represents the audio feature, from the main signal. For example, the music genre classification apparatus may extract Mel Frequency Cepstrum Coefficients (MFCC) from the main signal.

In step 250, the music genre classification apparatus generates probability model that may best represent the extracted audio parameter by using the Hidden Markov Model method. For example, the music genre classification apparatus may generate HMM according to the extracted MFCC by training the probability model using Baum-Welch algorithm or Segmental K-means algorithm.

In step 260, the music genre classification apparatus checks whether the HMMs are generated for all of the audio files. If the HMM is not generated for any of the audio files as a result of the above check, the music genre classification apparatus may proceed to step 210. Accordingly, the HMMs may be generated for the plurality of audio files.

In step 270, the music genre classification apparatus measures the similarity between the HMMs. For example, the music genre classification apparatus may measure the similarity between the HMMs by using Dynamic Time Warping (DTW).

In step 280, the music genre classification apparatus clusters the audio files based on the measured similarities. For example, the music genre classification apparatus may cluster the audio files by using the Markov Clustering Algorithm (MCL Algorithm) based on the measured similarities. Accordingly, the music genre classification apparatus may classify the plurality of audio files according to music genres.

Some embodiments of the present disclosure are described, however, various embodiments disclosed herein are not intended to be limiting with the true scope and spirit being indicated by the following claims.

A method for music genre classification and an apparatus therefor in one embodiment are designed to remove signals interfering in deciding music genres for the audio signals generated from the music files and to classify the music files after analyzing the features of the audio signals where the interfering signals are removed, thereby enabling to correctly classify the music files according to genres.

From the foregoing, it will be appreciated that various embodiments of the present disclosure have been described herein for purposes of illustration, and that various modifications may be made without departing from the scope and spirit of the present disclosure.

1. A method for music genre classification, comprising:
generating Hidden Markov Models corresponding to a plurality of audio files; and
classifying the audio files according to music genres by clustering the audio files based on the similarity between the generated Hidden Markov Models;
wherein the generating Hidden Markov Models corresponding to the plurality of audio files comprises:
performing an independent component analysis (-I-GA) for an audio signal generated from each of the respective audio files among the plurality of audio files to generate independent signals corresponding to the audio signal;
selecting at least one independent signal as a main signal among the independent signals based on energies of the generated independent signals;
extracting an audio feature parameter from the main signal; and
generating a Hidden Markov Model for the respective audio file based on the extracted audio feature parameter.

2. The method according to claim 1, wherein the selecting at least one independent signal as a main signal among the independent signals based on energies of the generated independent signals comprises selecting, as the main signal, an independent signal having the highest energy among the generated independent signals by comparing energies of the generated independent signals.

3. The method according to claim 1, wherein the audio feature parameter is Mel Frequency Cepstrum Coefficients.

4. The method according to claim 1, wherein the classifying the audio files according to music genres by clustering the audio files based on the similarity between the generated Hidden Markov Models comprises measuring the similarities between the generated Hidden Markov Models by using Dynamic Time Warping.

5. The method according to claim 4, wherein the classifying the audio files according to music genres by clustering the audio files based on the similarity between the generated Hidden Markov Models comprises clustering the audio files by using Markov Clustering Algorithm based on the measured similarities.

6. An apparatus for music genre classification, comprising:
a model generator, which generates Hidden Markov Models corresponding to a plurality of audio files; and
an audio file classifier, which classifies the audio files according to music genres by clustering the audio files based on the similarity between the generated Hidden Markov Models;
wherein the model generator comprises:
an independent component analyzer, which performs an independent component analysis for an audio signal generated from a respective audio file from among the plurality of audio files to generate independent signals corresponding to the audio signal;
a main signal selector, which selects at least one independent signal as a main signal from among the independent signals based on energies of the generated independent signals;
a feature extractor, which extracts an audio feature parameter from the main signal; and
a Hidden Markov Model generator, which generates a Hidden Markov Model for the respective audio file based on the extracted audio feature parameter.

7. The apparatus according to claim 6, wherein the main signal selector selects, as the main signal, an independent signal having the highest energy among the generated independent signals by comparing energies of the generated independent signals.

8. The apparatus according to claim 6, wherein the audio feature parameter is Mel Frequency Cepstrum Coefficients.

9. The apparatus according to claim 6, wherein the audio file classifier further comprises a similarity measuring unit, which measures the similarity of the generated Hidden Markov Models by using Dynamic Time Warping.

10. The apparatus according to claim 9, wherein the audio file classifier further comprises a clustering unit, which clusters the audio files by using a Markov Clustering Algorithm based on the measured similarities.
